(19) United States
(12) Patent Application Publication
(10) Pub. No.: US 2008/0206492 A1
(43) Pub. Date: Aug. 28, 2008

(54) Double-Sided Pressure-Sensitive Adhesive Tapes For the Production of Lc Displays With Light-Reflecting and Light-Absorbing Properties

(75) Inventors: Marc Husemann, Hamburg (DE); Reinhard Storbeck, Hamburg (DE)

Correspondence Address: NORRIS, MCLAUGHLIN & MARCUS, PA, 875 THIRD AVENUE, 18TH FLOOR, NEW YORK, NY, 10022, US

(73) Assignee: TESA AG, Hamburg (DE)

(21) Appl. No.: 11/917,295

(22) PCT Filed: Dec. 2, 2005
(86) PCT No.: PCT/EP2005/056407

§ 371 Date: Mar. 25, 2008

(30) Foreign Application Priority Data
Jun. 13, 2005 (DE) 10 2005 027 394.7

(51) Int. Cl. C09J 5/00; B32B 7/12; C09J 7/02

(52) U.S. Cl. 428/1.5; 428/354; 156/306.6

(57) ABSTRACT

A pressure-sensitive adhesive tape, in particular for producing a bond between optical liquid crystal data displays (LCDs), comprising an upper and a lower side with light-reflecting properties on the upper side and light-absorbing properties on the lower side and further comprising a support film with an upper and a lower side, each side of the pressure-sensitive adhesive tape having an outer pressure-sensitive layer, and said adhesive tape being characterized in that at least one metallic reflective layer for the reflection of light is provided between the outer pressure-sensitive layers of at least one pressure-sensitive adhesive layer, colored black, for the absorption of light and in that at least the outer pressure-sensitive layer on the upper side is transparent.

The invention relates to double-sided pressure-sensitive adhesive tapes having multilayer carrier constructions, having multilayer adhesive constructions, and having light-reflecting and absorbing properties for producing liquid-crystal displays (LCDs).

Pressure-sensitive adhesive tapes in the age of industrialization are widespread processing auxiliaries. Particularly for use in the computer industry, very exacting requirements are imposed on pressure-sensitive adhesive tapes. As well as having a low outgassing behavior, the pressure-sensitive adhesive tapes ought to be suitable for use across a wide temperature range and ought to fulfill certain optical properties.

One field of use is that of liquid crystal displays (LCDs) which are needed for computers, TVs, laptops, PDAs, cell phones, digital cameras, etc. FIG. 1 shows the approach for a double-sided adhesive tape having a black layer for absorption and a layer for reflection, in accordance with the prior art; the key to the reference numerals is as follows:

| | |
|---|---|
| 1 | LCD glass |
| 2 | double-sided black-white adhesive tape |
| 3 | pressure-sensitive adhesive |
| 4 | light source (LED) |
| 5 | light beams |
| 6 | double-sided adhesive tape |
| 7 | optical waveguide |
| 8 | reflective film |
| 9 | LCD casing |
| 10 | black absorbing side of adhesive tape |
| 11 | reflecting side |
| 12 | visible region |
| 13 | “blind” region |

For the production of LC displays, LEDs (light-emitting diodes), as the light source, are bonded to the LCD module. Generally, black, double-sided pressure-sensitive adhesive tapes are used for this purpose. The aim of the black coloration is to prevent light penetrating from inside to outside and vice versa in the region of the double-sided pressure-sensitive adhesive tape.

There are already numerous approaches in existence for achieving such black coloring.

On the other hand, there is a desire to increase the light efficiency of the back light module, and so it is preferred to use double-sided adhesive tapes which are black (light-absorbing) on one side and light-reflecting on the other side.

For the production of the black side there are numerous approaches in existence.

One approach to the production of black double-sided pressure-sensitive adhesive tapes lies in the coloration of the carrier material. Within the electronics industry great preference is attached to using double-sided pressure-sensitive adhesive tapes having polyester film carriers (PET), on account of their very good diecuttability. The PET carriers can likewise be colored with carbon black or black pigments, in order to achieve light absorption. The disadvantage of this existing approach is the low level of light absorption. In very thin carrier layers it is possible to incorporate only a relatively small number of particles of carbon black or other black pigment, with the consequence that absorption of the light is incomplete. With the eye, and also with relatively intensive light sources (with a luminance of greater than 600 candelas), it is then possible to determine the deficient absorption.

Another approach to producing black double-sided pressure-sensitive adhesive tapes concerns the production of a two-layer carrier material by means of coextrusion. Carrier films are generally produced by extrusion. As a result of the coextrusion, as well as the conventional carrier material, a second, black layer is coextruded, fulfilling the function of light absorption. This approach too has a variety of disadvantages. For example, for extrusion it is necessary to use antiblocking agents, which then lead to what are called pinholes in the product. These pinholes are optical point defects (light passes through these holes) and adversely impact the functioning in the LCD.

A further problem is posed by the layer thicknesses, since the two layers are first of all shaped individually in the die and it is therefore possible overall to realize only relatively thick carrier layers, with the result that the film becomes relatively thick and inflexible and hence its conformation to the surfaces to be bonded is poor. Moreover, the black layer must likewise be relatively thick, since otherwise it is not possible to realize complete absorption. A further disadvantage lies in the altered mechanical properties of the carrier material, since the mechanical properties of the black layer are different from those of the original carrier material (e.g., pure PET). A further disadvantage of the two-layer version of the carrier material is the difference in anchoring of the adhesive to the coextruded carrier material. In this embodiment, there is always a weak point in the double-sided adhesive tape.

In a further approach, a black colored coating layer is coated onto the carrier material.

This coating may take place single-sidedly or double-sidedly on the carrier. This approach too has a variety of disadvantages. On the one hand, here as well, defects (pinholes) are readily formed, and are introduced by antiblocking agents during the film extrusion operation. These pinholes are unacceptable for final application in the LC display. Furthermore, the maximum absorption properties do not correspond to the requirements, since it is possible to apply only relatively thin coating layers. There is also an upper limit on the layer thicknesses, since otherwise the mechanical properties of the carrier material would suffer alteration.

In the development of LC displays there is a trend developing. On the one hand, the LC displays are to become more lightweight and flatter, and there is a rising demand for ever larger displays with ever higher resolution.

For this reason, the design of the displays has been changed, and the light source, accordingly, is coming nearer and nearer to the LCD panel, with the consequence of an increased risk of more and more light penetrating from the outside into the marginal zone (“blind area”) of the LCD panel (see FIG. 1). With this development, therefore, there is also an increase in the requirements imposed on the shading properties (blackout properties) of the double-sided adhesive tape, and accordingly there is a need for new approaches to the production of black adhesive tapes.

On the other side, moreover, the double-sided adhesive tape is to be reflecting.

Known for this purpose are double-sided pressure-sensitive adhesive tapes which possess a black carrier and on one side a metallic layer. With these pressure-sensitive adhesive tapes, a distinct improvement has been obtained in respect of light reflection on one side and absorption on the opposite side, and yet, as a result of the antiblocking agents in the carrier layer, irregularities occur in the reflecting side.

To obtain a reflecting layer, it is possible to in turn provide the pressure-sensitive adhesive (PSA) with reflecting particles. The reflection properties obtainable, however, are relatively inadequate.

JP 2002-350612 describes double-sided adhesive tapes for LCD panels with light-protecting properties. The function is achieved by means of a metal layer applied on one or both sides to the carrier film, it also being possible, additionally, for the carrier film to have been colored. As a result of the metallization, the production of the adhesive tape is relatively costly and inconvenient, and the adhesive tape itself possesses a deficient flat lie.

JP 2002-023663 also describes double-sided adhesive tapes for LCD panels that have light-protecting properties. Here again, the function is achieved by means of a metal layer applied on one or both sides to the carrier film.

DE 102 43 215 A describes double-sided adhesive tapes for LC displays that have light-absorbing properties on the one side and light-reflecting properties on the other side. That document describes black/silver double-sided PSA tapes. A transparent or colored carrier film is metallized on one side and colored black on the other side. In this way, good reflection properties are achieved, but the absorption properties are still inadequate, since defects, from the film, for example, due to antiblocking agents, are only coated over, and hence the light can still pass through at this point (pinholes).

For the adhesive bonding of LC displays and for their production, therefore, there continues to be a need for double-sided PSA tapes which do not have the deficiencies described above, or which have them only to a reduced extent.

It is therefore an object of the invention to provide a double-sided pressure-sensitive adhesive tape which avoids the presence of pinholes, and is capable of fully absorbing light, and which features improved reflection of light.

This object is achieved by means of the pressure-sensitive adhesive tapes of the invention, as they are set out in the main claim. In the context of this invention it has surprisingly been found that these properties can be achieved with a two-layer pressure-sensitive adhesive and a PET film metallization. The dependent claims relate to advantageous embodiments of the subject matter of the invention, and to the use of the pressure-sensitive adhesive tapes of the invention.

The main claim accordingly provides a pressure-sensitive adhesive tape, in particular for the production of an adhesive bond of optical liquid-crystal data displays (LCDs), having a top side and a bottom side, having light-reflecting properties on the top side and light-absorbing properties on the bottom side, additionally having a carrier film having a top side and a bottom side, the pressure-sensitive adhesive tape being furnished on both sides with an outer pressure-sensitive adhesive layer, and additionally at least one metallically reflecting layer for effecting light reflection, and at least one black-colored pressure-sensitive adhesive layer for effecting light absorption, are each provided between the outer pressure-sensitive adhesive layers, and at least the outer pressure-sensitive adhesive layer on the top side is transparent.

In one preferred embodiment of the invention both outer pressure-sensitive adhesive layers are transparent.

In one advantageous embodiment the at least one metallically reflecting layer is located between the carrier film and the pressure-sensitive adhesive layer on the top side.

In another advantageous embodiment the at least one metallically reflecting layer is provided between the carrier film and black-colored pressure-sensitive adhesive layer. In this case the carrier film is preferably of transparent or semitransparent configuration.

In a likewise-preferred embodiment there are at least two metallically reflecting layers provided, of which one is provided between the carrier film and the pressure-sensitive adhesive layer on the top side, and the other is provided between the carrier film and the black-colored pressure-sensitive adhesive layer. In an advantageous version of this embodiment the carrier film is likewise transparent or semitransparent.

Set out below are some advantageous embodiments of the adhesive tape of the invention, without any wish that the invention should be unnecessarily restricted through the choice of the examples.

The pressure-sensitive adhesive layers (d) and (d′) on the two sides of the pressure-sensitive adhesive tape of the invention may in each case be identical or different, particularly with regard to their configuration (layer thickness and the like) and their chemical composition. With particular preference the PSA is transparent at least on the side of the pressure-sensitive adhesive tape. In the inventive sense, however, it can also be advantageous to configure the PSAs on both sides of the pressure-sensitive adhesive tape to be transparent.

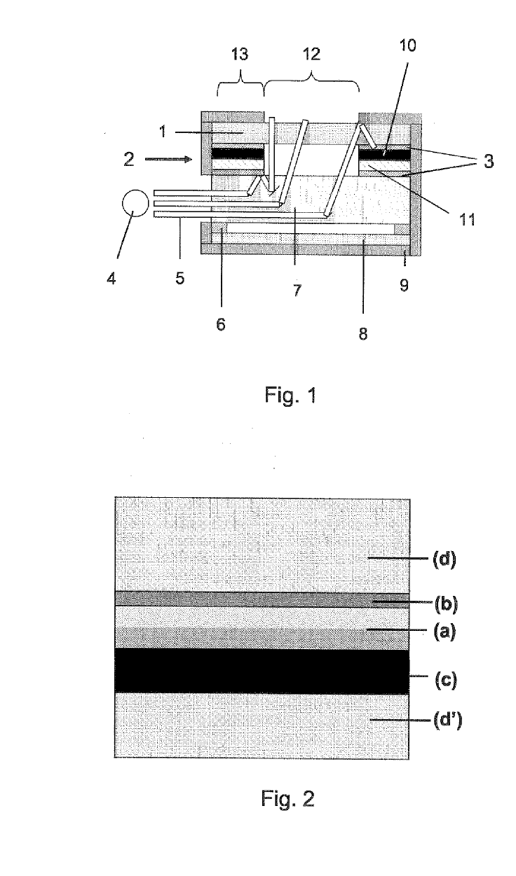

In a first advantageous embodiment the inventive pressure-sensitive adhesive tape is composed of a carrier film layer (a), a metallically reflecting layer (b), a chromophoric pressure-sensitive adhesive (c), and two pressure-sensitive adhesive layers (d) and (d′), of which at least the pressure-sensitive adhesive layer (d) on the top side is transparent. Here, the metallically reflecting layer and the chromophoric PSA are preferably located on different sides of the carrier film. This embodiment is depicted in FIG. 2.

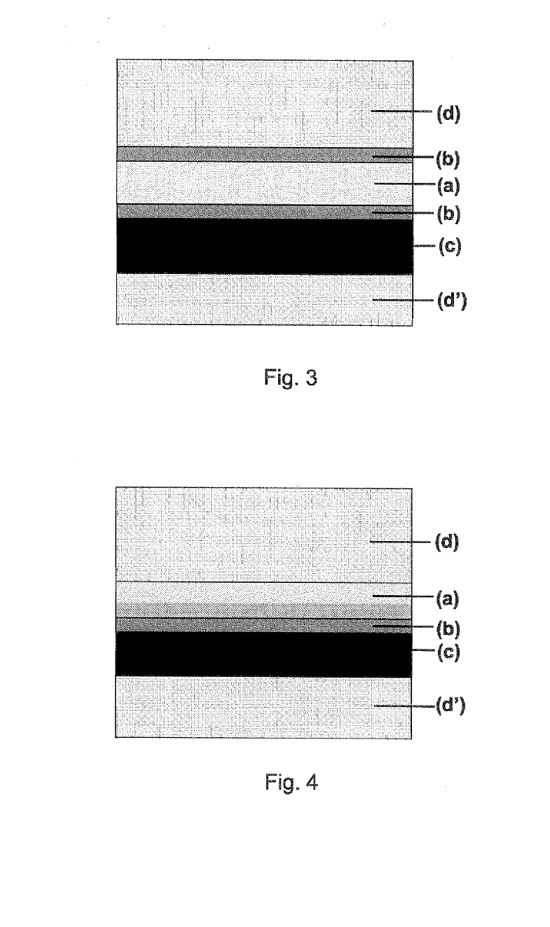

In another preferred embodiment of the invention, as shown by FIG. 3, the double-sided pressure-sensitive adhesive tape is composed of a carrier film (a), two metallically reflecting layers (b), a chromophoric pressure-sensitive adhesive (c), and two pressure-sensitive adhesive layers (d) and (d′). Again the pressure-sensitive adhesive layer (d) on the top side is preferably transparent.

In a further preferred embodiment of the invention, in accordance with FIG. 4, the double-sided pressure-sensitive adhesive tape is composed of a carrier film (a), a metallically reflecting layer (b), a chromophoric PSA layer (c), an two pressure-sensitive adhesive layers (d) and (d′). Here, the metallically reflecting layer (b) and the chromophoric PSA layer (c) are located on the same side of the carrier film.

In this case the metallically reflecting layer (b) is located advantageously between the film carrier, which in this case is transparent or at least semitransparent, and the chromophoric PSA layer (c). The pressure-sensitive adhesive layer (d) on the top side is in turn advantageously transparent.

The invention is elucidated in more detail below. The limit values indicated are to be understood as inclusive values, i.e., as included within the specified limit range.

The carrier film (a) is preferably between 5 and 250 μm, more preferably between 8 and 50 μm, very preferably between 12 and 36 μm thick and is preferably transparent. The layers (b) are metallically lustrous and light-reflecting. Advantageous as a metallically reflecting layer is a silver-colored coating system; in a further preferred embodiment the film (a) is vapor-coated on one or both sides with metal, such as with aluminum or silver. A combination of the aforementioned configurations (i.e., vapor coating with subsequent coating system, or vice versa) is also realizable. The thickness of the layers (b) is preferably between 5 nm and 200 nm.

The layers (c) are chromophoric dark, very preferably black, PSA layers, each with a thickness of preferably between 5 μm and 100 μm. The PSA for (c) may be different in chemical nature and may contain different black pigments, which exert advantageous effects on the light-absorbing properties.

The PSA layers (d) and (d′) possess preferably a thickness of in each case between 5 μm and 250 μm. The individual layers (b), (c), (d), and (d′) may differ in respect of thickness within the double-sided pressure-sensitive adhesive tape, so that, for example, it is possible to apply PSA layers (d) and (d′) differing in thickness, or it is possible to select individual layers, two or more layers, or else all the layers as identical.

### Carrier Film (a)

As film carriers it is possible in principle to use all filmlike polymer carriers which are transparent. Thus it is possible, for example, to use polyethylene, polypropylene, polyimide, polyester, polyamide, polymethacrylate, fluorinated polymer films, etc. In one particularly preferred embodiment, polyester films are used, with particular preference PET films (polyethylene terephthalate). The films may be present in detensioned form or may have one or more preferential directions. Preferential directions are obtained by drawing in one or in two directions. For the production operation of films, PET films, for example, antiblocking agents are normally employed, such as silicon dioxide, silica chalk, chalk or zeolites, for example.

Antiblocking agents are intended to prevent the sticking-together of flat polymeric films under pressure and temperature to form blocks. The typical approach is to incorporate the antiblocking agents into the thermoplastic mixture. In that case the particles function as spacers.

Films of this kind can be employed with advantage for the inventive double-sided adhesive tapes. For the inventive pressure-sensitive adhesive tapes, however, it is also possible to employ films which contain no antiblocking agents or contain antiblocking agents only in a very low fraction. An example of such a film is, for example, the Hostaphan™ 5000 series from Mitsubishi Polyester Film (PET 5211, PET 5333 PET 5210).

Furthermore, preference is given to very thin PET films, 12 μm in thickness for example, on account of the very good adhesive properties that they permit for the double-sided adhesive tape, since in this case the film is very flexible and is able to conform well to the surface roughnesses of the substrates that are to be bonded.

To improve the anchoring of the coating layers it is very advantageous if the films are pretreated. The films may be etched (e.g., trichloroacetic acid or trifluoroacetic acid), corona- or plasma-pretreated, or furnished with a primer (e.g., Saran).

Furthermore it is advantageous—particularly when the film material is transparent or semitransparent—to add color pigments or chromophoric particles to the film material. Thus, for example, carbon black is suitable for black coloring, and titanium dioxide particles for white coloring. The pigments or particles ought, however, to be preferably smaller in diameter than the final layer thickness of the carrier film. Optimum colorations can be achieved with 10% to 40% by weight particle fractions, based on the film material.

### Reflecting Layer (b)

To produce a highly reflecting side it is possible on the one hand to apply a silver-colored coating material to the film layer (a) or to vapor-coat the film layer (a) on one or both sides with a metal, aluminum or silver for example. For the silver-colored coating material version, a binder matrix is blended with silver color pigments and/or metal particles. Examples of suitable binder matrices are polyurethanes or polyesters, which have a high refractive index and a high transparency. Alternatively the color pigments can be bound into a polyacrylate or polymethacrylate matrix and then cured as coating material.

In one very preferred embodiment the film layer (a) is vapor-coated (sputtered) on both sides with aluminum or silver. In order to obtain particularly outstanding reflecting properties, the sputtering operation for the vapor deposition must be controlled in such a way that the aluminum or silver is applied very uniformly, in order to obtain optimum reflection (avoidance of scattering effects). Moreover, in one very preferred version, the PET film is pretreated with plasma before being vapor-coated with aluminum or silver. The use of the reflecting layer (b) has the twin effects of selectively reflecting the light and of preventing or reducing the transmission of the light through the carrier material. In addition, surface roughnesses of the carrier film are compensated.

For the production operation it may be advantageous if the reflecting side is additionally protected by a clearcoat prior to coating with the PSA.

### PSA Layer (c)

The PSA layer (c) may fulfill different functions. In one advantageous embodiment of the invention the layer (c) possesses the function of substantially complete absorption of the external light. The transmittance of the pressure-sensitive adhesive tape in this case, in a wavelength range of 300-800 nm, is therefore preferably <0.5%, more preferably <0.1%, very preferably <0.01%. This is advantageously achieved in accordance with the invention using a black PSA layer.

In one inventive embodiment to which great preference is accorded, carbon black or graphite particles are mixed into the pressure-sensitive adhesive matrix as black-coloring particles. At a very high level of additization (>20% by weight), this additization produces not only the substantially complete light absorption but also an electrical conductivity, so that the inventive double-sided pressure-sensitive adhesive tapes likewise exhibit antistatic properties. The pressure-sensitive adhesive matrix used can encompass all of the PSA systems known to the skilled worker. Examples of suitable PSA systems include acrylate, natural-rubber, synthetic-rubber, silicone or EVA compositions. In addition it is also possible to process the other PSAs known to the skilled worker, as they are set out, for example, in the “Handbook of Pressure Sensitive Adhesive Technology” by Donatas Satas (van Nostrand, N.Y. 1989).

For natural rubber adhesives, the natural rubber is preferably milled to a molecular weight (weight average) of not below about 100 000 daltons, preferably not below 500 000 daltons, and additized.

In the case of rubber/synthetic rubber as starting material for the adhesive, there are wide possibilities for variation. Use may be made of natural rubbers or of synthetic rubbers, or of any desired blends of natural rubbers and/or synthetic rubbers, it being possible for the natural rubber or natural rubbers to be chosen in principle from all available grades, such as, for example, crepe, RSS, ADS, TSR or CV types, in accordance with the purity level and viscosity level required, and for the synthetic rubber or synthetic rubbers to be chosen from the group of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate copolymers (EVA) and polyurethanes and/or blends thereof.

With further preference it is possible, in order to improve the processing properties of the rubbers, to add to them thermoplastic elastomers with a weight fraction of 10% to 50% by weight, based on the overall elastomer fraction. As representatives, mention may be made at this point, in particular, of the particularly compatible styrene-isoprene-styrene (SIS) and styrene-butadiene-styrene (SBS) types.

In one inventively preferred embodiment use is preferably made of (meth)acrylate PSAs.

(Meth)acrylate PSAs, which are obtainable by free-radical addition polymerization, advantageously consist to the extent of at least 50% by weight of at least one acrylic monomer from the group of the compounds of the following general formula:

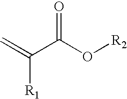

In this formula, the radical R₁ is H or CH₃ and the radical R₂ is H or CH₃ or is selected from the group containing the branched and unbranched, saturated alkyl groups having 1-30 carbon atoms.

The monomers are preferably chosen such that the resulting polymers can be used, at room temperature or higher temperatures, as PSAs, particularly such that the resulting polymers possess pressure-sensitive adhesive properties in accordance with the “Handbook of Pressure Sensitive Adhesive Technology” by Donatas Satas (van Nostrand, N.Y. 1989).

For the inventive embodiment it is of particular advantage if the pressure-sensitive adhesive matrix from (c) is identical with the PSA (d) and/or (d′). The use of the same PSA allows the viscoelastic profile of the layers (c) and (d) and/or (d′) to be strengthened, which in turn leads to a significant improvement in the technical adhesive properties (this is a particular advantage over adhesive tapes coated with black coating materials or adhesive tapes furnished with thick black carriers). For acrylate PSAs this can be achieved by means of a preferred polymer glass transition temperature T_{g} of ≦25° C. Correspondingly, the monomers are very preferably selected in such a way, and the quantitative composition of the monomer mixture advantageously chosen in such a way, as to result in the desired T_{g} for the polymer in accordance with an equation (E1) analogous to the Fox equation (E1) (cf. T. G. Fox, Bull. Am. Phys. Soc. 1 (1956) 123).

$$\frac{1}{{T}_{g}} = {\sum }_{n} \frac{{w}_{n}}{{T}_{g , n}} \qquad ( E 1 )$$

In this equation, n represents the serial number of the monomers used, wₙ the mass fraction of the respective monomer n (% by weight), and T_{g,n} the respective glass transition temperature of the homopolymer of the respective monomer n, in K.

A further advantage of this invention is that chromophoric black particles are unable to migrate to the substrate to be bonded, since the transparent PSAs are located on the outsides of the pressure-sensitive adhesive tape. This is an important aspect for repositionability, since in an extreme case, in the event of an incorrect adhesive bond, corresponding detachment would leave black residues on the LCD film, and the entire component would therefore be unusable. In the context of this invention, in one particularly preferred embodiment, therefore, it is advantageous for (c) and (d) and/or (d′) to have the same pressure-sensitive adhesive matrix.

A further advantage of the identical or pressure-sensitive adhesive matrices lies in the reduced proclivity of the dyes or chromophoric particles to migrate into the adhesive layers (d) and/or (d′). Consequently there is no risk of the chromophoric particles, owing for example to a difference in polarity, being more soluble in one matrix and migrating toward it.

Furthermore, as a result of the two-layer construction, it is also possible for additional functions to be implemented. For instance, expandants can be added in layer (c), and may subsequently increase the vibration properties, or further fillers may be added to it, which lower the production cost of the adhesive tape without influencing the adhesively bonding PSA layer (d) and/or (d′) as a result.

PSAs (d) and (d′)

In one preferred embodiment the PSAs (d) and (d′) are identical on both sides of the pressure-sensitive adhesive tape. In one specific embodiment, however, it may also be an advantage for the PSAs (d) and (d′) to be different from one another, in particular in their layer thickness and/or their chemical composition. Thus in this way, for example, different pressure-sensitive adhesion properties can be set. PSA systems used for the inventive double-sided pressure-sensitive adhesive tape include preferably acrylate, natural-rubber, synthetic-rubber, silicone or EVA adhesives. Where the double-sided inventive pressure-sensitive adhesive tape has high reflection on at least one side, the PSA preferably has a high transparency at least on that side.

Furthermore, it is also possible to process the other PSAs known to the skilled worker, as they are set out, for example, in the “Handbook of Pressure Sensitive Adhesive Technology” by Donatas Satas (van Nostrand, N.Y. 1989).

For natural-rubber adhesives the natural rubber is preferably milled to a molecular weight (weight average) of not below about 100 000 daltons, preferably not below 500 000 daltons, and additized.

In the case of rubber/synthetic rubber as starting material for the adhesive, there are wide possibilities for variation. Use may be made of natural rubbers or of synthetic rubbers, or of any desired blends of natural rubbers and/or synthetic rubbers, it being possible for the natural rubber or natural rubbers to be chosen in principle from all available grades, such as, for example, crepe, RSS, ADS, TSR or CV types, in accordance with the purity level and viscosity level required, and for the synthetic rubber or synthetic rubbers to be chosen from the group of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate copolymers (EVA) and polyurethanes and/or blends thereof.

With further preference it is possible, in order to improve the processing properties of the rubbers, to add to them thermoplastic elastomers with a weight fraction of 10% to 50% by weight, based on the overall elastomer fraction. As representatives, mention may be made at this point, in particular, of the particularly compatible styrene-isoprene-styrene (SIS) and styrene-butadiene-styrene (SBS) types.

In one inventively preferred embodiment use is preferably made of (meth)acrylate PSAs.

(Meth)acrylate PSAs employed in accordance with the invention, which are obtainable by free-radical addition polymerization, advantageously consist to the extent of at least 50% by weight of at least one acrylic monomer from the group of the compounds of the following general formula:

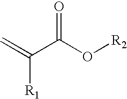

In this formula the radical R₁ is ═H or CH₃ and the radical R₂═H or CH₃ or is selected from the group containing the branched and unbranched, saturated alkyl groups having 1-30 carbon atoms.

The monomers are preferably chosen such that the resulting polymers can be used, at room temperature or higher temperatures, as PSAs, particularly such that the resulting polymers possess pressure-sensitive adhesive properties in accordance with the “Handbook of Pressure Sensitive Adhesive Technology” by Donatas Satas (van Nostrand, N.Y. 1989).

In a further inventive embodiment the comonomer composition is chosen such that the PSAs can be used as heat-activable PSAs.

The polymers can be obtained preferably by polymerizing a monomer mixture which is composed of acrylic esters and/or methacrylic esters and/or the free acids thereof, with the formula CH₂═CH(R₁)(COOR₂), where R₁═H or CH₃ and R₂ is an alkyl chain having 1-20 carbon atoms or is H.

The molar masses M_{w} (weight average) of the polyacrylates used amount preferably to M_{w}≧2 200 000 g/mol.

In one way which is greatly preferred, acrylic or methacrylic monomers are used which are composed of acrylic and methacrylic esters having alkyl groups comprising 4 to 14 carbon atoms, and preferably comprise 4 to 9 carbon atoms. Specific examples, without wishing to be restricted by this enumeration, are methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and the branched isomers thereof, such as isobutyl acrylate, 2-ethylhexyl acrylate, 2-ethylhexyl methacrylate, isooctyl acrylate, and isooctyl methacrylate, for example.

Further classes of compound which can be used are monofunctional acrylates and/or methacrylates of bridged cycloalkyl alcohols consisting of at least 6 carbon atoms. The cycloalkyl alcohols can also be substituted, by C-1-6 alkyl groups, halogen atoms or cyano groups, for example. Specific examples are cyclohexyl methacrylates, isobornyl acrylate, isobornyl methacrylates, and 3,5-dimethyladamantyl acrylate.

In an advantageous procedure monomers are used which carry polar groups such as carboxyl radicals, sulfonic and phosphonic acid, hydroxyl radicals, lactam and lactone, N-substituted amide, N-substituted amine, carbamate, epoxy, thiol, alkoxy or cyano radicals, ethers or the like.

Moderate basic monomers are, for example, N,N-dialkyl-substituted amides, such as, for example, N,N-dimethylacrylamide, N,N-dimethylmethylmethacrylamide, N-tert-butylacrylamide, N-vinylpyrrolidone, N-vinyllactam, dimethylaminoethyl methacrylate, dimethylaminoethyl acrylate, diethylaminoethyl methacrylate, diethylaminoethyl acrylate, N-methylolmethacrylamide, N-(butoxymethyl)methacrylamide, N-methylolacrylamide, N-(ethoxymethyl)acrylamide, N-isopropylacrylamide, this enumeration not being exhaustive.

Further preferred examples are hydroxyethyl acrylate, hydroxypropyl acrylate, hydroxyethyl methacrylate, hydroxypropyl methacrylate, allyl alcohol, maleic anhydride, itaconic anhydride, itaconic acid, glyceridyl methacrylate, phenoxyethyl acrylate, phenoxyethyl methacrylate, 2-butoxyethyl methacrylate, 2-butoxyethyl acrylate, cyanoethyl methacrylate, cyanoethyl acrylate, glyceryl methacrylate, 6-hydroxyhexyl methacrylate, vinylacetic acid, tetrahydrofurfuryl acrylate, β-acryloyloxypropionic acid, trichloroacrylic acid, fumaric acid, crotonic acid, aconitic acid, and dimethylacrylic acid, this enumeration not being exhaustive.

In one further very preferred procedure use is made as monomers of vinyl esters, vinyl ethers, vinyl halides, vinylidene halides, and vinyl compounds having aromatic rings and heterocycles in α-position. Here again, mention may be made, nonexclusively, of some examples: vinyl acetate, vinylformamide, vinylpyridine, ethyl vinyl ether, vinyl chloride, vinylidene chloride, and acrylonitrile.

Moreover, in one advantageous procedure, use is made of photoinitiators having a copolymerizable double bond. Suitable photoinitiators include Norrish I and II photoinitiators. Examples include benzoin acrylate and an acrylated benzophenone from UCB (Ebecryl P 36®). In principle it is possible to copolymerize any photoinitiators which are known to the skilled worker and which are able to crosslink the polymer by way of a free-radical mechanism under UV irradiation. An overview of possible photoinitiators which can be used and can be functionalized by a double bond is given in Fouassier: “Photoinitiation, Photopolymerization and Photocuring: Fundamentals and Applications”, Hanser-Verlag, Munich 1995. Carroy et al. in “Chemistry and Technology of UV and EB Formulation for Coatings, Inks and Paints”, Oldring (Ed.), 1994, SITA, London is used as a supplement.

In another preferred procedure the comonomers described are admixed with monomers which possess a high static glass transition temperature. Suitable components include aromatic vinyl compounds, an example being styrene, in which the aromatic nuclei consist preferably of C₄ to C₁₈ units and may also include heteroatoms. Particularly preferred examples are 4-vinylpyridine, N-vinylphthalimide, methylstyrene, 3,4-dimethoxystyrene, 4-vinylbenzoic acid, benzyl acrylate, benzyl methacrylate, phenyl acrylate, phenyl methacrylate, t-butylphenyl acrylate, t-butylphenyl methacrylate, 4-biphenylyl acrylate, 4-biphenylyl methacrylate, 2-naphthyl acrylate, 2-naphthyl methacrylate, and mixtures of these monomers, this enumeration not being exhaustive.

As a result of the increase in the aromatic fraction there is a rise in the refractive index of the PSA, and the scattering between LCD glass and PSA as a result, for example, of extraneous light is minimized.

For further development it is possible to admix resins to the PSAs. As tackifying resins for addition it is possible to use all tackifier resins previously known and described in the literature. Representatives that may be mentioned include pinene resins, indene resins, and rosins, their disproportionated, hydrogenated, polymerized, and esterified derivatives and salts, the aliphatic and aromatic hydrocarbon resins, terpene resins and terpene-phenolic resins, and also C5, C9, and other hydrocarbon resins. Any desired combinations of these and further resins may be used in order to adjust the properties of the resultant adhesive in accordance with requirements. Generally speaking it is possible to employ any resins which are compatible (soluble) with the polyacrylate in question: in particular, reference may be made to all aliphatic, aromatic and alkylaromatic hydrocarbon resins, hydrocarbon resins based on single monomers, hydrogenated hydrocarbon resins, functional hydrocarbon resins, and natural resins. Reference is expressly made to the presentation of the state of knowledge in the “Handbook of Pressure Sensitive Adhesive Technology” by Donatas Satas (van Nostrand, 1989).

Here as well, the transparency is improved using, preferably, transparent resins which are highly compatible with the polymer. Hydrogenated or partly hydrogenated resins frequently feature these properties.

In addition it is possible optionally to add plasticizers, further fillers (such as, for example, fibers, carbon black, zinc oxide, chalk, solid or hollow glass beads, microbeads made of other materials, silica, silicates), nucleators, electrically conductive materials, such as, for example, conjugated polymers, doped conjugated polymers, metal pigments, metal particles, metal salts, graphite, etc., expandants, compounding agents and/or aging inhibitors, in the form of, for example, primary and secondary antioxidants or in the form of light stabilizers.

In a further advantageous embodiment of the invention the PSA (d′) applied to the black layer (c) comprises light-absorbing particles, such as black color pigments or carbon-black particles or graphite particles as filler, for example.

In addition it is possible to admix crosslinkers and promoters for crosslinking. Examples of suitable crosslinkers for electron beam crosslinking and UV crosslinking include difunctional or polyfunctional acrylates, difunctional or polyfunctional isocyanates (including those in blocked form), and difunctional or polyfunctional epoxides. In addition it is also possible for thermally activable crosslinkers to have been added, such as Lewis acid, metal chelates or polyfunctional isocyanates, for example.

For optional crosslinking with UV light it is possible to add UV-absorbing photoinitiators to the PSAs. Useful photoinitiators whose use is very effective are benzoin ethers, such as benzoin methyl ether and benzoin isopropyl ether, substituted acetophenones, such as 2,2-diethoxyacetophenone (available as Irgacure 651® from Ciba Geigy®), 2,2-dimethoxy-2-phenyl-1-phenylethanone, dimethoxyhydroxyacetophenone, substituted α-ketols, such as 2-methoxy-2-hydroxypropiophenone, aromatic sulfonyl chlorides, such as 2-naphthylsulfonyl chloride, and photoactive oximes, such as 1-phenyl-1,2-propanedione 2-(O-ethoxycarbonyl)oxime, for example.

The abovementioned photoinitiators and others which can be used, and also others of the Norrish I or Norrish II type, can contain the following radicals: benzophenone, acetophenone, benzil, benzoin, hydroxyalkylphenone, phenyl cyclohexyl ketone, anthraquinone, trimethylbenzoylphosphine oxide, methylthiophenylmorpholine ketone, aminoketone, azobenzoin, thioxanthone, hexaarylbisimidazole, triazine, or fluorenone, it being possible for each of these radicals to be additionally substituted by one or more halogen atoms and/or by one or more alkyloxy groups and/or by one or more amino groups or hydroxy groups. A representative overview is given by Fouassier: “Photoinitiation, Photopolymerization and Photocuring: Fundamentals and Applications”, Hanser-Verlag, Munich 1995. Carroy et al. in “Chemistry and Technology of UV and EB Formulation for Coatings, Inks and Paints”, Oldring (Ed.), 1994, SITA, London can be used as a supplement.

### Preparation Process for the Acrylate PSAs

For the polymerization the monomers are chosen such that the resultant polymers can be used at room temperature or higher temperatures as PSAs, in particular such that the resulting polymers possess pressure-sensitive adhesive properties in accordance with the “Handbook of Pressure Sensitive Adhesive Technology” by Donatas Satas (van Nostrand, N.Y. 1989).

In order to achieve a preferred polymer glass transition temperature T_{g} of ≦25° C. for PSAs it is very preferred, in accordance with the comments made above, to select the monomers in such a way, and choose the quantitative composition of the monomer mixture advantageously in such a way, as to result in the desired T_{g} for the polymer in accordance with the Fox equation (E1) (cf. T. G. Fox, Bull. Am. Phys. Soc. 1 (1956) 123).

$$\frac{1}{{T}_{g}} = {\sum }_{n} \frac{{w}_{n}}{{T}_{g , n}} \qquad ( E 1 )$$

In this equation, n represents the serial number of the monomers used, wₙ the mass fraction of the respective monomer n (% by weight), and T_{g,n} the respective glass transition temperature of the homopolymer of the respective monomer n, in K.

For the preparation of the poly(meth)acrylate PSAs it is advantageous to carry out conventional free-radical polymerizations. For the polymerizations which proceed free-radically it is preferred to employ initiator systems which also contain further free-radical initiators for the polymerization, especially thermally decomposing, free-radical-forming azo or peroxo initiators. In principle, however, all customary initiators which are familiar to the skilled worker for acrylates are suitable. The production of C-centered radicals is described in Houben Weyl, Methoden der Organischen Chemie, Vol. E 19a, pp. 60-147. These methods are employed, preferentially, in analogy.

Examples of free-radical sources are peroxides, hydroperoxides, and azo compounds; some nonlimiting examples of typical free-radical initiators that may be mentioned here include potassium peroxodisulfate, dibenzoyl peroxide, cumene hydroperoxide, cyclohexanone peroxide, di-t-butyl peroxide, azodiisobutyronitrile, cyclohexylsulfonyl acetyl peroxide, diisopropyl percarbonate, t-butyl peroctoate, and benzpinacol. In one very preferred version the free-radical initiator used is 1,1′-azobis(cyclohexane-carbonitrile) (Vazo 88™ from DuPont) or azodiisobutyronitrile (AIBN).

The weight-average molecular weights M_{w} of the PSAs formed in the free-radical polymerization are very preferably chosen such that they are situated within a range of 200 000 to 4 000 000 g/mol; specifically for further use as electrically conductive hotmelt PSAs with resilience, PSAs are prepared which have average molecular weights M_{w} of 400 000 to 1 400 000 g/mol. The average molecular weight is determined by size exclusion chromatography (GPC) or matrix-assisted laser desorption/ionization mass spectrometry (MALDI-MS).

The polymerization may be conducted without solvent, in the presence of one or more organic solvents, in the presence of water, or in mixtures of organic solvents and water. The aim is to minimize the amount of solvent used. Suitable organic solvents are pure alkanes (e.g., hexane, heptane, octane, isooctane), aromatic hydrocarbons (e.g., benzene, toluene, xylene), esters (e.g., ethyl, propyl, butyl or hexyl acetate), halogenated hydrocarbons (e.g., chlorobenzene), alkanols (e.g., methanol, ethanol, ethylene glycol, ethylene glycol monomethyl ether), and ethers (e.g., diethyl ether, dibutyl ether) or mixtures thereof. A water-miscible or hydrophilic cosolvent may be added to the aqueous polymerization reactions in order to ensure that the reaction mixture is present in the form of a homogeneous phase during monomer conversion. Cosolvents which can be used with advantage for the present invention are chosen from the following group, consisting of aliphatic alcohols, glycols, ethers, glycol ethers, pyrrolidines, N-alkylpyrrolidinones, N-alkylpyrrolidones, polyethylene glycols, polypropylene glycols, amides, carboxylic acids and salts thereof, esters, organic sulfides, sulfoxides, sulfones, alcohol derivatives, hydroxy ether derivatives, amino alcohols, ketones and the like, and also derivatives and mixtures thereof.

The polymerization time—depending on conversion and temperature—is between 2 and 72 hours. The higher the reaction temperature which can be chosen, i.e., the higher the thermal stability of the reaction mixture, the shorter can be the chosen reaction time.

As regards initiation of the polymerization, the introduction of heat is essential for the thermally decomposing initiators. For these initiators the polymerization can be initiated by heating to from 50 to 160° C., depending on initiator type.

For the preparation it can also be of advantage to polymerize the (meth)acrylate PSAs without solvent. A particularly suitable technique for use in this case is the prepolymerization technique. Polymerization is initiated with UV light but taken only to a low conversion of about 10-30%. The resulting polymer syrup can then be welded, for example, into films (in the simplest case, ice cubes) and then polymerized through to a high conversion in water. These pellets can subsequently be used as acrylate hot-melt adhesives, it being particularly preferred to use, for the melting operation, film materials which are compatible with the polyacrylate. For this preparation method as well it is possible to add the thermally conductive materials before or after the polymerization.

Another advantageous preparation process for the poly(meth)acrylate PSAs is that of anionic polymerization. In this case the reaction medium used preferably comprises inert solvents, such as aliphatic and cycloaliphatic hydrocarbons, for example, or else aromatic hydrocarbons.

The living polymer is in this case generally represented by the structure P_{L}(A)-Me, where Me is a metal from group I, such as lithium, sodium or potassium, and P_{L}(A) is a growing polymer from the acrylate monomers. The molar mass of the polymer under preparation is controlled by the ratio of initiator concentration to monomer concentration. Examples of suitable polymerization initiators include n-propyllithium, n-butyllithium, sec-butyllithium, 2-naphthyllithium, cyclohexyllithium, and octyllithium, though this enumeration makes no claim to completeness. Furthermore, initiators based on samarium complexes are known for the polymerization of acrylates (Macromolecules, 1995, 28, 7886) and can be used here.

It is also possible, furthermore, to employ difunctional initiators, such as 1,1,4,4-tetraphenyl-1,4-dilithiobutane or 1,1,4,4-tetraphenyl-1,4-dilithioisobutane, for example. Coinitiators can likewise be employed. Suitable coinitiators include lithium halides, alkali metal alkoxides, and alkylaluminum compounds. In one very preferred version the ligands and coinitiators are chosen so that acrylate monomers, such as n-butyl acrylate and 2-ethylhexyl acrylate, for example, can be polymerized directly and do not have to be generated in the polymer by transesterification with the corresponding alcohol.

Methods suitable for preparing poly(meth)acrylate PSAs with a narrow molecular weight distribution also include controlled free-radical polymerization methods. In that case it is preferred to use, for the polymerization, a control reagent of the general formula:

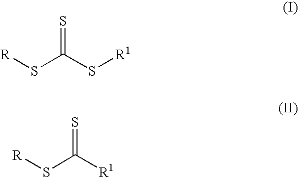

in which R and R¹ are chosen independently of one another or identical, and
branched and unbranched C₁ to C₁₈ alkyl radicals; C₃ to C₁₈ alkenyl radicals; C₃ to C₁₈ alkynyl radicals;
C₁ to C₁₈ alkoxy radicals;
C₃ to C₁₈ alkynyl radicals; C₃ to C₁₈ alkenyl radicals; C₁ to C₁₈ alkyl radicals substituted by at least one OH group or a halogen atom or a silyl ether;
C₂-C₁₈ heteroalkyl radicals having at least one oxygen atom and/or one NR* group in the carbon chain, R* being any radical (particularly an organic radical);
C₃-C₁₈ alkynyl radicals, C₃-C₁₈ alkenyl radicals, C₁-C₁₈ alkyl radicals substituted by at least one ester group, amine group, carbonate group, cyano group, isocyano group and/or epoxy group and/or by sulfur;
C₃-C₁₂ cycloalkyl radicals;
C₆-C₁₈ aryl or benzyl radicals;
hydrogen.

Control reagents of type (I) are preferably composed of the following compounds: halogen atoms therein are preferably F, Cl, Br or I, more preferably Cl and Br. Outstandingly suitable alkyl, alkenyl and alkynyl radicals in the various substituents include both linear and branched chains.

Examples of alkyl radicals containing 1 to 18 carbon atoms are methyl, ethyl, propyl, isopropyl, butyl, isobutyl, t-butyl, pentyl, 2-pentyl, hexyl, heptyl, octyl, 2-ethylhexyl, t-octyl, nonyl, decyl, undecyl, tridecyl, tetradecyl, hexadecyl, and octadecyl.

Examples of alkenyl radicals having 3 to 18 carbon atoms are propenyl, 2-butenyl, 3-butenyl, isobutenyl, n-2,4-pentadienyl, 3-methyl-2-butenyl, n-2-octenyl, n-2-dodecenyl, isododecenyl, and oleyl.

Examples of alkynyl radicals having 3 to 18 carbon atoms are propynyl, 2-butynyl, 3-butynyl, n-2-octynyl, and n-2-octadecynyl.

Examples of hydroxy-substituted alkyl radicals are hydroxypropyl, hydroxybutyl, and hydroxyhexyl.

Examples of halogen-substituted alkyl radicals are dichlorobutyl, monobromobutyl, and trichlorohexyl.

An example of a suitable C₂-C₁₈ heteroalkyl radical having at least one oxygen atom in the carbon chain is —CH₂—CH₂—O—CH₂—CH₃.

Examples of C₃-C₁₂ cycloalkyl radicals include cyclopropyl, cyclopentyl, cyclohexyl, and trimethylcyclohexyl.

Examples of C₆-C₁₈ aryl radicals include phenyl, naphthyl, benzyl, 4-tert-butylbenzyl, and other substituted phenyls, such as ethyl, toluene, xylene, mesitylene, isopropylbenzene, dichlorobenzene or bromotoluene.

The above enumerations serve only as examples of the respective groups of compounds, and make no claim to completeness.

Other compounds which can also be used as control reagents include those of the following types:

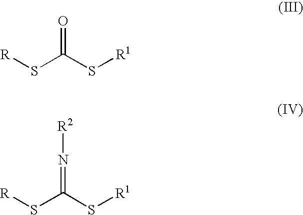

where R², again independently from R and R¹, may be selected from the group recited above for these radicals.

In the case of the conventional ‘RAFT’ process, polymerization is generally carried out only up to low conversions (WO 98/01478 A1) in order to produce very narrow molecular weight distributions. As a result of the low conversions, however, these polymers cannot be used as PSAs and in particular not as hotmelt PSAs, since the high fraction of residual monomers adversely affects the technical adhesive properties; the residual monomers contaminate the solvent recyclate in the concentration operation; and the corresponding self-adhesive tapes would exhibit very high outgassing behavior. In order to circumvent this disadvantage of low conversions, the polymerization in one particularly preferred procedure is initiated two or more times.

As a further controlled free-radical polymerization method it is possible to carry out nitroxide-controlled polymerizations. For free-radical stabilization, in a favorable procedure, use is made of nitroxides of type (Va) or (Vb):

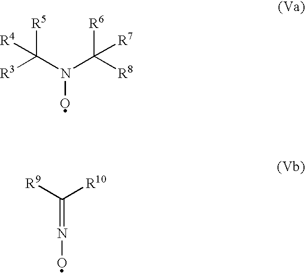

where R³, R⁴, R⁵, R⁶, R⁷, R⁸, R⁹, and R¹⁰ independently of one another denote the following compounds or atoms:
i) halides, such as chlorine, bromine or iodine, for example,
ii) linear, branched, cyclic, and heterocyclic hydrocarbons having 1 to 20 carbon atoms, which may be saturated, unsaturated or aromatic,
iii) esters —COOR¹¹, alkoxides —OR¹² and/or phosphonates —PO(OR¹³)₂, where R¹¹, R¹² or R¹³ stand for radicals from group ii).

Compounds of type (Va) or (Vb) can also be attached to polymer chains of any kind (primarily such that at least one of the abovementioned radicals constitutes a polymer chain of this kind) and may therefore be used for the synthesis of polyacrylate PSAs. With greater preference, controlled regulators for the polymerization of compounds of the type are used:
2,2,5,5-tetramethyl-1-pyrrolidinyloxyl (PROXYL), 3-carbamoyl-PROXYL, 2,2-dimethyl-4,5-cyclohexyl-PROXYL, 3-oxo-PROXYL, 3-hydroxylimine-PROXYL, 3-aminomethyl-PROXYL, 3-methoxy-PROXYL, 3-t-butyl-PROXYL, 3,4-di-t-butyl-PROXYL
2,2,6,6-tetramethyl-1-piperidinyloxyl (TEMPO), 4-benzoyloxy-TEMPO, 4-methoxy-TEMPO, 4-chloro-TEMPO, 4-hydroxy-TEMPO, 4-oxo-TEMPO, 4-amino-TEMPO, 2,2,6,6-tetraethyl-1-piperidinyloxyl, 2,2,6-trimethyl-6-ethyl-1-piperidinyloxyl
N-tert-butyl 1-phenyl-2-methylpropyl nitroxide
N-tert-butyl 1-(2-naphthyl)-2-methylpropyl nitroxide
N-tert-butyl 1-diethylphosphono-2,2-dimethylpropyl nitroxide
N-tert-butyl 1-dibenzylphosphono-2,2-dimethylpropyl nitroxide
N-(1-phenyl-2-methylpropyl) 1-diethylphosphono-1-methylethyl nitroxide
di-t-butyl nitroxide
diphenyl nitroxide
t-butyl t-amyl nitroxide.

A series of further polymerization methods in accordance with which the PSAs can be prepared by an alternative procedure can be chosen from the prior art:

U.S. Pat. No. 4,581,429 A discloses a controlled-growth free-radical polymerization process which uses as its initiator a compound of the formula R′R″N—O—Y, in which Y is a free-radical species which is able to polymerize unsaturated monomers. In general, however, the reactions have low conversion rates. A particular problem is the polymerization of acrylates, which takes place only with very low yields and molar masses. WO 98/13392 A1 describes open-chain alkoxyamine compounds which have a symmetrical substitution pattern. EP 735 052 A1 discloses a process for preparing thermoplastic elastomers having narrow molar mass distributions. WO 96/24620 A1 describes a polymerization process in which very specific free-radical compounds, such as phosphorus-containing nitroxides based on imidazolidine, for example, are employed. WO 98/44008 A1 discloses specific nitroxyls based on morpholines, piperazinones, and piperazinediones. DE 199 49 352 A1 describes heterocyclic alkoxyamines as regulators in controlled-growth free-radical polymerizations. Corresponding further developments of the alkoxyamines or of the corresponding free nitroxides improve the efficiency for the preparation of polyacrylates.

As a further controlled polymerization method, atom transfer radical polymerization (ATRP) can be used advantageously to synthesize the polyacrylate PSAs, in which case use is made preferably as initiator of monofunctional or difunctional secondary or tertiary halides and, for abstracting the halide(s), of complexes of Cu, Ni, Fe, Pd, Pt, Ru, Os, Rh, Co, Ir, Ag or Au (EP 0 824 111 A1; EP 826 698 A1; EP 824 110 A1; EP 841 346 A1; EP 850 957 A1). The various possibilities of ATRP are further described in the specifications U.S. Pat. No. 5,945,491 A, U.S. Pat. No. 5,854,364 A, and U.S. Pat. No. 5,789,487 A.

### Coating Process, Treatment of the Carrier Material

For preparation, in one preferred embodiment the pressure-sensitive adhesive is coated from solution onto the carrier material. To increase the anchoring of the PSA it is possible optionally to pretreat the layers (b) and/or (c) and (c′). Thus pretreatment may be carried out, for example, by corona or by plasma, a primer can be applied from the melt or from solution, or etching may take place chemically.

Particularly in the case of the metallic layer, however, the corona power ought to be minimized, since otherwise pinholes are burnt into the film. For the coating of the PSA from solution, heat is supplied, in a drying tunnel for example, to remove the solvent and, if appropriate, initiate the crosslinking reaction.

The polymers described above can also be coated, furthermore, as hotmelt systems (i.e., from the melt). For the preparation process it may therefore be necessary to remove the solvent from the PSA. In this case it is possible in principle to use any of the techniques known to the skilled worker. One very preferred technique is that of concentration using a single-screw or twin-screw extruder. The twin-screw extruder can be operated corotatingly or counterrotatingly. The solvent or water is preferably distilled off over two or more vacuum stages. Counterheating is also carried out depending on the distillation temperature of the solvent. The residual solvent fractions amount to preferably <1%, more preferably <0.5%, and very preferably <0.2%. Further processing of the hotmelt takes place from the melt.

For coating as a hotmelt it is possible to employ different coating processes. In one version the PSAs are coated by a roll coating process. Different roll coating processes are described in the “Handbook of Pressure Sensitive Adhesive Technology”, by Donatas Satas (van Nostrand, N.Y. 1989). In another version, coating takes place via a melt die. In a further preferred process, coating is carried out by extrusion. Extrusion coating is performed preferably using an extrusion die. The extrusion dies used may come advantageously from one of the three following categories: T-dies, fishtail dies and coathanger dies. The individual types differ in the design of their flow channels. Through the coating it is also possible for the PSAs to undergo orientation.

For the production of the two-layer PSA on one side there are three different particularly preferred methods:

a) Coextrusion

In this case the layers (c) and (d) are coated simultaneously from a coextrusion die, so that the PSAs can be applied in one step. This is no problem particularly when the viscosities of the PSAs (c) and (d) are comparable.

b) Subsequent Coating from Solution

In this case the PSA (c) is first applied from solution to the carrier and dried, and then the PSA (d) is applied from solution in a second coat. This operation can take place in two worksteps or in one machine workstep, in which case application from solution takes place with an applicator mechanism (c), drying is carried out in a short drying tunnel, and then drying (d) takes place, again with an applicator mechanism, and then complete drying takes place in a longer drying tunnel.

c) Simultaneous Coating from Solution

In this case, application from solution takes place with one die and two channels, with both layers, (c) and (d), being applied almost simultaneously and then dried simultaneously in one step.

In addition it may be necessary for the PSAs to be crosslinked. In one preferred version, crosslinking takes place thermally, with electron beams and/or UV radiation.

UV crosslinking irradiation is carried out with shortwave ultraviolet irradiation in a wavelength range from 200 to 400 nm, depending on the UV photoinitiator used; in particular, irradiation is carried out using high-pressure or medium-pressure mercury lamps at an output of 80 to 240 W/cm. The irradiation intensity is adapted to the respective quantum yield of the UV photoinitiator and the degree of crosslinking that is to be set.

Furthermore, in one advantageous embodiment of the invention, the PSAs are crosslinked using electron beams. Typical irradiation equipment which can be advantageously employed includes linear cathode systems, scanner systems, and segmented cathode systems, where electron beam accelerators are employed. A detailed description of the state of the art and the most important process parameters are found in Skelhorne, Electron Beam Processing, in Chemistry and Technology of UV and EB formulation for Coatings, Inks and Paints, Vol. 1, 1991, SITA, London. The typical acceleration voltages are situated in the range between 50 kV and 500 kV, preferably between 80 kV and 300 kV. The scatter doses employed range between 5 and 150 kGy, in particular between 20 and 100 kGy.

It is also possible to employ both crosslinking processes, or other processes allowing high-energy irradiation.

The invention further provides for the use of the inventive double-sided pressure-sensitive adhesive tapes for adhesive bonding or production of LC displays. For use as pressure-sensitive adhesive tape it is possible for the double-sided pressure-sensitive adhesive tapes to have been lined with one or two release films or release papers. In one preferred embodiment, use is made of siliconized or fluorinated films or papers, such as glassine, HDPE or LDPE coated papers, for example, which have in turn been given a release coat based on silicones or fluorinated polymers. One particularly preferred embodiment uses siliconized PET films for lining.

The pressure-sensitive adhesive tapes of the invention are particularly advantageous for the adhesive bonding of light-emitting diodes (LEDs) as a light source to the LCD module.

### EXAMPLES

The invention is described below, without wishing any unnecessary restriction to result from the choice of the examples.

The following test methods were employed.

### Test Methods

### A. Transmittance

The transmittance was measured in the wavelength range from 190 to 900 nm using a Uvikon 923 from Biotek Kontron. Measurement is made at 23° C. The absolute transmittance is reported in % as the value at 550 nm, relative to complete light absorption (0% transmittance=no light transmission; 100% transmittance=complete light transmission).

### B. Pinholes

A very strong light source of commercially customary type (e.g., Liesegangtrainer 400 KC type 649 overhead projector, 36 V halogen lamp, 400 W) is given completely lightproof masking. The mask contains in its center a circular aperture having a diameter of 5 cm. The double-sided LCD adhesive tape is placed atop said circular aperture. In a completely darkened environment, the number of pinholes is then counted electronically or visually. When the light source is switched on, these pinholes are visible as translucent dots.

### C. Reflection

The reflection test is carried out in accordance with DIN standards 5063 part 3 and 5033 parts 3 and 4. The instrument used was a type LMT Ulbricht sphere (50 cm diameter) in conjunction with a type LMT tau-ρ-meter digital display instrument. The integral measurements are made using a light source corresponding to standard light A and V(λ)-adapted Si photoelement. Measurement was carried out against a glass reference sample. The reflectance is reported as the sum of directed and scattered light fractions in %.

### Polymer 1

A 200 l reactor conventional for free-radical polymerizations was charged with 2400 g of acrylic acid, 64 kg of 2-ethylhexyl acrylate, 6.4 kg of methyl acrylate and 53.3 kg of acetone/isopropanol (95:5). After nitrogen gas had been passed through the reactor for 45 minutes with stirring, the reactor was heated to 58° C. and 40 g of 2,2′-azoisobutyronitrile (AIBN) were added. Subsequently the external heating bath was heated to 75° C. and the reaction was carried out constantly at this external temperature. After a reaction time of 1 h a further 40 g of AIBN were added. After 5 h and 10 h, dilution was carried out with 15 kg each time of acetone/isopropanol (95:5). After 6 h and 8 h, 100 g each time of dicyclohexyl peroxydicarbonate (Perkadox 16®, Akzo Nobel) in solution in each case in 800 g of acetone were added. The reaction was terminated after a reaction time of 24 h, and the reaction mixture cooled to room temperature. Before the composition is used for coating, polymer 1 is diluted with isopropanol to 30% solids content. Subsequently, with vigorous stirring, 0.3% by weight of aluminum(III) acetylacetonate (3% strength solution, isopropanol), based on polymer 1, is mixed in.

### Carbon Black Composition 1

In a drum the polymer 1 is diluted with special-boiling-point spirit to a solids content of 30%. Subsequently, with vigorous stirring, 8% by weight of carbon black (Printex™ 25, Degussa AG) and 0.3% by weight of aluminum(III) acetylacetonate (3% strength solution, isopropanol), based in each case on polymer 1, is mixed in. For homogenization the solution is homogenized for 10 minutes with a homogenizer (Ultraturrax).

### Carbon Black Composition 2

In a drum the polymer 1 is diluted with special-boiling-point spirit to a solids content of 30%. Subsequently, with vigorous stirring, 10% by weight of carbon black (Printex™ 25, Degussa AG) and 0.3% by weight of aluminum(III) acetylacetonate (3% strength solution, isopropanol), based in each case on polymer 1, is mixed in. For homogenization the solution is homogenized for 10 minutes with a homogenizer (Ultraturrax).

### Crosslinking

The PSAs are coated from solution onto a siliconized PET film 75 μm thick (release film from Siliconature) and the coatings are dried in a drying cabinet at 100° C. for 10 minutes.

### Film (Al Vapor Coating):

A 12 μm PET film, extruded without antiblocking agent, from Mitsubishi (Hostaphan™ 52) was vapor-coated on one or both sides with aluminum until a completely coherent aluminum layer had been applied. The film was vapor-coated in a width of 300 mm by the sputtering method. In this method, positively charged, ionized argon gas is passed into a high-vacuum chamber. The charged ions then impinge on a negatively charged Al plate and, at the molecular level, detach particles of aluminum, which then deposit on the polyester film which is passed over the plate.

### Example 1 (Black/Silver)

First of all carbon black composition 1 is applied evenly from solution over one side of the double-sidedly Al vapor-coated film (based on Hostaphan™ 5210), and dried at 100° C. for 10 minutes. The coat weight is 50 g/m². Then polymer 1 is applied evenly from solution to this coat, and is dried at 100° C. for 10 minutes. The coat weight for this layer is likewise 50 g/m². On the opposite side the polymer 1 is then applied evenly at a rate of 100 g/m², drying taking place again at 100° C. for 10 minutes.

### Example 2 (Black/Silver)

First of all carbon black composition 2 is applied evenly from solution over one side of the double-sidedly Al vapor-coated film (based on Hostaphan™ 5210), and dried at 100° C. for 10 minutes. The coat weight is 50 g/m². Then polymer 1 is applied evenly from solution to this coat, and is dried at 100° C. for 10 minutes. The coat weight for this layer is likewise 50 g/m². On the opposite side the polymer 1 is then applied evenly at a rate of 100 g/m², drying taking place again at 100° C. for 10 minutes.

### Example 3 (Black/Silver)

First of all carbon black composition 2 is applied evenly from solution over the nonmetallic side of the Al vapor-coated film (based on Hostaphan™ 5210), and dried at 100° C. for 10 minutes. The coat weight is 50 g/m². Then polymer 1 is applied evenly from solution to this coat, and is dried at 100° C. for 10 minutes. The coat weight for this layer is likewise 50 g/m². On the opposite side (metallic side) the polymer 1 is then applied evenly at a rate of 100 g/m², drying taking place again at 100° C. for 10 minutes.

### Example 4 (Black/Silver)

First of all carbon black composition 2 is applied evenly from solution over the metallic side of the Al vapor-coated film (based on Hostaphan™ 5210), and dried at 100° C. for 10 minutes. The coat weight is 50 g/m². Then polymer 1 is applied evenly from solution to this coat, and is dried at 100° C. for 10 minutes. The coat weight for this layer is likewise 50 g/m². On the opposite side (nonmetallic side) the polymer 1 is then applied evenly at a rate of 100 g/m², drying taking place again at 100° C. for 10 minutes.

### Results

Examples 1 to 4 were tested according to test methods A, B and C. The results are shown in table 1.

TABLE 1

| | Transmittance | Pinholes | Reflectance (total) |
|---|---|---|---|
| Example | (test A) | (test B) | (test C) |
| Example 1 | <0.1% | 0 | 86.4% |
| Example 2 | <0.1% | 0 | 86.2% |
| Example 3 | <0.1% | 0 | 86.6% |
| Example 4 | <0.1% | 0 | 81.7% |

From the results from table 1 it is apparent that examples 1 to 4 have outstanding properties in respect of optical defects (absence of pinholes) and transmittance. Furthermore, test C showed that examples 1 to 4 not only have light-absorbing properties but also possess, on the metallic side, very high light-reflecting properties as well. For the LCD application this means that the light yield in the light channel is significantly increased.

1. A pressure-sensitive adhesive tape
having a top side and a bottom side, having light-reflecting properties on the top side and light-absorbing properties on the bottom side,
additionally having a carrier film having a top side and a bottom side,
the pressure-sensitive adhesive tape being furnished on both sides of the carrier film with an outer pressure-sensitive adhesive layer,
wherein
at least one metallically reflecting layer for effecting light reflection, and at least one black-colored pressure-sensitive adhesive layer for effecting light absorption, are each provided between the outer pressure-sensitive adhesive layers, and at least the outer pressure-sensitive adhesive layer on the top side is transparent.

2. The pressure-sensitive adhesive tape of claim 1, wherein the at least one metallically reflecting layer is provided between the carrier film and the pressure-sensitive adhesive layer on the top side.

3. The pressure-sensitive adhesive tape of claim 1, wherein the at least one metallically reflecting layer is provided between the carrier film and the black-colored pressure-sensitive adhesive layer.

4. The pressure-sensitive adhesive tape of claim 3, wherein the carrier film is transparent.

5. The pressure-sensitive adhesive tape of claim 2, wherein at least two metallically reflecting layers are provided, a first of which is provided between the carrier film and the pressure-sensitive adhesive layer on the top side and a second of which is provided between the carrier film and the black-colored pressure-sensitive adhesive layer.

6. The pressure-sensitive adhesive tape of claim 1, wherein both outer pressure-sensitive adhesive layers are transparent.

7. The pressure-sensitive adhesive tape of claim 1, comprising the following layer sequence:
transparent pressure-sensitive adhesive (layer d)-metallically reflecting layer (layer b)-carrier film (layer a)-black-colored pressure-sensitive adhesive (layer c)-pressure-sensitive adhesive (layer d′).

8. The pressure-sensitive adhesive tape of claim 1, comprising the following layer sequence:
transparent pressure-sensitive adhesive (layer d)-metallically reflecting layer (layer b)-carrier film (layer a)-metallically reflecting layer (layer b)-black-colored pressure-sensitive adhesive (layer c)-pressure-sensitive adhesive (layer d′).

9. The pressure-sensitive adhesive tape of claim 1, comprising the following layer sequence:
transparent pressure-sensitive adhesive (layer d)-transparent or semitransparent carrier film (layer a′)-metallically reflecting layer (layer b)-black-colored pressure-sensitive adhesive (layer c)-pressure-sensitive adhesive (layer d′).

10. A method of bonding components of an optical liquid-crystal display comprising bonding said components with a pressure-sensitive adhesive tape of claim 1.

11. The method of claim 10, wherein said components are components of an LCD glass.

12. A liquid-crystal data display device comprising a pressure-sensitive adhesive tape of claim 1.
